(19) United States
(12) Patent Application Publication
(10) Pub. No.: US 2009/0055224 A1
(43) Pub. Date: Feb. 26, 2009

(54) Health Expense Account, Health Insurance And Financial Product, And System And Method For Providing Employee Health Insurance Benefits

(76) Inventors: Vikram Kashyap, San Francisco, CA (US); Jeremy J. Blackburn, Inver Grove Heights, MN (US)

Correspondence Address: PERKINS COIE LLP, P.O. BOX 1208, SEATTLE, WA, 98111-1208, US

(21) Appl. No.: 11/842,917

(22) Filed: Aug. 21, 2007

(51) Int. Cl. G06Q 40/00

(52) U.S. Cl. 705/4

(57) ABSTRACT

Financial and health and medical care product and service. Health expense account, financial product, health care product that include or interact with the health expense account. System and method for providing products and services to employers and employees using these accounts and financial products and health care products, and to business methods and business models that derive revenues from the products and services and from interactions between and among the providers of components thereof.

### CROSS-REFERENCE TO RELATED APPLICATIONS

Co-pending patent application Ser. No. ______ entitled SUB-ACCOUNTING FOR AN OMNIBUS ACCOUNT naming inventors Jeremy J. Blackburn, Vikram A. Kashyap, and Anthony T. Banas and filed 13 Aug. 2007, describes certain sub-accounting systems and methods that may optionally but advantageously be used in conjunction with the inventive system, method, health care and financial products described herein, and which application is hereby incorporated by reference.

### FIELD OF THE INVENTION

This invention pertains to the financial and health and medical care product and services industries, and more particularly pertains to a Health Expense Account, to financial products and health care products that include or interact with the Health Expense Account, to a system and method for providing products and services to employers and employees using these accounts and financial products and health care products, and to business methods and business models that derive revenues from the products and services and from interactions between and among the providers of components thereof.

### BACKGROUND

Traditionally, many businesses and companies in the United States, also referred to as employers, provide health care or medical insurance to their employees (and frequently to the employee's family and dependents) in one of two ways: either through a commercial group health care insurance policy, or by self insuring the employees so that health care expenses are reimbursed through an employer fund. Another alternative has been to not offer any health or medical insurance benefit to employees. In the later instance, the employee may be on his/her own to procure health care or medical insurance coverage and without any benefit of a monetary contribution from the employer. Heath care insurance and medical care insurance are used synonymously here. As used herein the terms or phrases “health care” (or “healthcare”) and “medical care” are used synonymously as are the terms “health” and “medical”, and the terms “health care insurance” and “medical care insurance”.

Companies and corporations often have difficultly hiring employees if they do not provide a health care insurance benefit or one that does not compete economically or on the basis of coverage with competitors. However, some employers or businesses have difficulty funding or providing even modest health care benefits for their employees due to the costs involved for the insurance and for administering the plan. This may result in businesses not offering employees any employer sponsored health care or medical insurance or offering any health care benefit contribution.

Rapidly spiraling health care costs and unpredictability relative to future increases in costs have increasingly dissuaded some employers from offering any health care or medical insurance to employees, and in some instances where the provision of health care benefits may be required only for full-time permanent employees, such employers have increasingly relied on either temporary employees or part-time employees to satisfy their employee needs.

Therefore, some businesses have not been able to provide all employees with health or medical insurance because of the cost of such policies and/or the cost of the policies plus the cost to administer the health or medical insurance plan at the company. And, as health insurance costs increase, the number of companies that are not able to provide health and medical insurance to their employees is increasing.

Conventional health and medical care plans may be problematic even when they are provided by an employer. For example, even well compensated employees in profitable businesses may not be able obtain the health care insurance they prefer because their employer provides a limited set of insurance options. In some instances, this may be the result of an employer being forced to satisfy the needs of a large and diverse employee population where employee salary or compensation spans a wide range. Administrative costs associated with managing too many different employer sponsored health care or medical insurance may also preclude such offerings. Often federally approved High Deductible Health Plans (HDHPs) may be one type of plan to be offered by an employer because the premium costs of such types of plans are significantly lower than similar plans with lower deductibles. Although HDHPs may offer significant advantages to employers, such high deductibles may not be acceptable to all employees, particularly lower salaried or hourly employees who may feel they need a greater safety net and guaranteed reimbursement for a larger set of typical health care claims without having to absorb the potential financial burden of high deductibles before the insurance coverage kicks in. The inability of the employee to enroll in an HDHP (e.g., one's employer does not offer such a plan) also precludes the employee from having and holding a federally qualified Health Savings Account (HSA).

The High Deductible Health Plan (HDHP) is a relatively new health plan product that became available through recent federal legislation and which may be combined with a Health Savings Account (HSA) or a Health Reimbursement Arrangement (HRA) to provide insurance coverage and a tax-advantaged way to help save for future medical expenses. The HDHP with an HSA or HRA gives the account holder some flexibility and discretion over how one uses one's health care dollars.

These HDHP advantages do not come without some possible negative tradeoffs or consequences. The possibly disadvantageous elements may include higher minimum annual deductible amounts of both self-coverage and for self and family coverage. They may also have annual out-of-pocket maximums, which are different and possibly higher than for non-HDHPs. Again, these factors may dissuade employers from providing an HDHP as the one company sponsored plan even though many employees may wish to participate in such plan because of the many advantages that they would realize.

Other characteristics, features, advantages, disadvantages, and requirements for the HDHP with possible HSA or HRA are known in the art, set forth in legislation and not otherwise described in detail herein. The United States Internal Revenue Service (IRS) Code and applicable rules and regulations pertaining to the HDHP and HSA as of the date of the filing of this patent application are hereby incorporated by reference.

A conventional HSA is a tax-sheltered trust account an individual owns or holds for the purpose of paying qualified medical expenses himself\herself, one's spouse, and one's dependents. When an individual enrolls in an HDHP, the particular health plan determines whether the individual is eligible for a HSA or an HRA based on the information provided.

Some of the general features of an HSA are provided for purposes of understanding the background of the invention as follows. One's own HSA voluntary contributions are tax-deductible. One's own HSA contributions are either tax-deductible or pre-tax (if made by payroll deduction) as set forth in the Internal Revenue Code. Interest earned on one's HSA account is currently tax-free, and tax-free withdrawals may be made for qualified medical expenses. Unused funds and interest are carried over, without limit, from year to year. One owns the HSA and it is one's to keep even when one changes plans, is employed by a different employer, or retires.

Typically, an HSA plan may save the account holder money through lower premiums, tax savings, and by the fact that money deposited in one's HSA account can be used to pay one's health insurance plan deductible and a wide variety of out-of-pocket medical expenses in the current year or in the future. The HSA cannot, however, be generally used to pay for health care plan insurance plan or policy premiums. Qualified medical expenses are in conformance with federal law and the IRS Code. HSA funds typically earn interest and the interest earnings are tax free.

The individual owns his/her account, so that one may keep the HSA, even if one changes health plans or changes or leaves employment. If one is no longer enrolled in an HDHP, then one is not eligible to make contributions to one's HSA, but one may still withdraw money for qualified medical expenses.

An HSA can be used to pay for qualified medical expenses, as defined by IRS Code 213(d) at the time of filing of this application. These expenses include for example, but are not limited to, medical plan deductibles, diagnostic services covered by the plan, dental treatment, long-term care insurance premiums, health insurance premiums if you are receiving Federal unemployment compensation, over-the-counter drugs, and some nursing services. For the vast majority of U.S. employees who are not receiving U.S. Federal unemployment compensation, health insurance premiums are not tax-deductible qualified medical expenses that may be reimbursed from an HSA.

Furthermore, HSA eligibility is restricted and requires participation in an HDHP, requires that the participant have no other health care insurance coverage other than those specifically allowed, and not be claimed as a dependent on someone else's tax return in order to be eligible for an HSA. Some examples of other coverage that would cause ineligibility are: a Health Care Flexible Spending Account (HC FSA), a spouse's Flexible Spending Account (FSA), a spouse's family enrollment in an HMO, other non-high deductible health insurance coverage, Medicare, or receipt of Veterans Administration (VA) benefits within the previous three months. However, one may still have other disability, dental, vision and long-term care insurance policies. It will therefore be appreciated that there are a number of factors that would or may restrict one's ability to have an HSA.

HRAs are employer-funded tax-sheltered accounts to reimburse allowable medical expenses. Typically, HDHP members who do not qualify for an HSA will be provided an HRA. HRAs may provide for tax-free withdrawals for qualified medical expenses, and carryover of unused credits from year to year. However, credits in an HRA do not earn interest and are forfeited if one switches health insurance plans. One's HRA may be administered by the health plan.

Although the U.S. law may change from time to time, as of the date of filing of this patent application, a high deductible health insurance policy can qualify for purposes of holding a HSA, as long as it meets the IRS requirements. For 2007, this deductible must be at least $1,100 for individuals or $2,200 for families, and the annual out-of-pocket expenses cannot exceed $5,500 for an individual or $11,000 for a family, including the deductible and co-payments (but not premiums). These deductibles and expense limits are expected to change over time in accordance with inflation and cost of living changes. Individuals can buy high deductible policies on their own, or through their employers.

It is the ability of an individual to buy or procure a high deductible health plan or policy on one's own even though it is not offered as an option through one's employer, such as through an employer's group insurance plan. This is an attractive and advantageous feature of embodiments of the invention.

### BRIEF DESCRIPTION OF THE DRAWINGS

FIG. 1 is an illustration showing an exemplary system configuration according to one non-limiting embodiment of the invention.

FIG. 2 is an illustration showing an alternative exemplary system configuration according to a second non-limiting embodiment of the invention.

FIG. 3 is an illustration showing an exemplary embodiment of an account service provider according to a non-limiting embodiment of the invention.

FIG. 4 is an illustration showing an exemplary embodiment of a business/employer interaction process that may occur during business registration with the service.

FIG. 5 is an illustration showing an exemplary embodiment of an employee interaction process which may occur during initial employee registration after the employer has registered and established an account for the employee.

FIG. 6 is an illustration showing a block diagram of a non-limiting example use case for setting up an employer account.

FIG. 7A and FIG. 7B are displays illustrating web portal screen interfaces presented to employers during account management.

FIG. 8 is an illustration showing a block diagram of a non-limiting example use case for setting up an individual employee account.

FIG. 9A and FIG. 9B are displays illustrating web portals presented to employees during account management.

### SUMMARY

In one aspect, an embodiment of the invention provides a health expense account structure. In one non-limiting embodiment, the health expense account structure comprises: a financial vehicle or container for depositing a monetary value having a present cash equivalence, the deposited monetary value corresponding to a pre-funded nominal defined contribution health care or medical care employer-to-employee benefit, and the deposited monetary value deposited into the financial vehicle or container is provided to fully satisfy any employee health care or medical care employment benefit.

In other aspects, embodiments of the invention provide health care and financial products. In one non-limiting embodiment, a health care financial product is provided, in which an amount of money is deposited by or on behalf of an employer in an account established for an employee to at least partially satisfy an employer assumed or legally mandated obligation to provide a health care benefit to the employee, the amount of money deposited being a defined contribution amount with which the employee may procure a health care or medical care insurance plan. In another non-limiting embodiment, the health care plan financial product, comprising: a health care account with at least one defined contribution deposit made to the account that is owned by an employee, and is for the benefit of the employee, and which is used for payment of an individual health or medical insurance policy premium and optionally payments for health care related expenses; and the at least one defined contribution deposit is made monthly and wherein once deposited are owned by the employee even if the employee ceases to be employed by the employer making the deposit.

In another aspect, the invention provides a method of providing a health care financial product. In one non-limiting embodiment, the method comprising: establishing an account by an employer or by an agent authorized by the employer to establish such account for the benefit of an employee; depositing an amount of money by or on behalf of the employer to at least in partially satisfy an employer assumed or legally mandated obligation to provide a health care benefit to the employee; and the amount of money deposited being a defined contribution amount with which the employee may procure a health care or medical care insurance plan.

In another aspect, the invention provides a network-based system for establishing and maintaining a health expense account and for optimizing employer and employee interaction and use of the account. In one non-limiting embodiment, the network-based system for establishing and maintaining a health expense account and for optimizing an employer and an employee interaction and use of the account, the system comprises: an account service provider that provides an electronic informational interaction mechanism between an employer and an employee, and directly or indirectly provides a network-based employer portal and a network-based employee portal for that interaction; a custodial financial institution that receives deposited money funds directly or indirectly from the employer and maintains a financial account that holds the money funds deposited by the employer for the beneficial use of the employee; a health care insurance company that provides a health care or medical care insurance plan or policy to the employee as an individual and is able to accept payment of the health care or medical care insurance policy premiums at the direction of the employee from the deposited funds in the financial account; and the account service provider, the custodial financial institution, and the health care insurance provider are at least intermittently coupled over a computer information network.

In another aspect, an embodiment of the invention provides a business method for procuring health insurance in a defined contribution manner using a tax-advantaged vehicle and leveraging on-line health insurance procurement. In one non-limiting embodiment, the business method for establishing and maintaining a health expense account and for optimizing an employer and an employee interaction and use of the account, the business method comprising: registering an employer with or through a service provider; establishing a particular financial account and identifying that particular financial account with a particular employee; depositing a nominal or pre-funded monetary amount into the financial account in satisfaction of a current defined contribution health care or medical care benefit due the employee; registering the employee with or through the service provider so that the employee is authorized to access the particular financial account including to make payments from the particular account; providing health care or medical care insurance information to the employee so that they may individually identify and procure a health care or medical care insurance plan or policy from a subscribing health care or medical care insurance provider; and facilitating payment of a health care or medical care premium payment directly from the particular financial account to the subscribing health care or medical care insurance provider.

In one non-limiting embodiment, the business method is implemented at least in part using a computer program and computer program product, the computer program product comprising a computer usable medium having computer readable program code means embodied in said medium for causing an application program to execute on at least one computer for effecting a business method for establishing and maintaining a health expense account and for optimizing an employer and an employee interaction and use of the account, the business method comprising: registering an employer with or through a service provider; establishing a particular financial account and identifying that particular financial account with a particular employee; depositing a nominal or pre-funded monetary amount into the financial account in satisfaction of a current defined contribution health care or medical care benefit due the employee; registering the employee with or through the service provider so that the employee is authorized to access the particular financial account including to make payments from the particular account; providing health care or medical care insurance information to the employee so that they may individually identify and procure a health care or medical care insurance plan or policy from a subscribing health care or medical care insurance provider; and facilitating payment of a health care or medical care premium payment directly from the particular financial account to the subscribing health care or medical care insurance provider.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in the Detailed Description section.

### DETAILED DESCRIPTION

Embodiments of the invention provides a novel financial account structure, system and method that permits U.S. business and possibly other entities (falling within the scope and control of federal laws and regulations including within the statutes, rules, regulations, and guidelines of the U.S. Internal Revenue Service) of any size to manage a defined contribution mechanism as it relates to the procurement of health or medical insurance. Such business might include very small businesses or employers, such as for example the so-called mom-and-pop businesses that may have only a single employee or a few employees, smaller or medium size companies that have more employees (for example, a few to a few dozen employees), as well as larger companies and multinational companies having a U.S. headquarters, U.S. subsidiary, or smaller division or office where the employee is to be provided with some measure of health or medical care benefits.

In another aspect, the invention enables a business or employer to allocate or set aside a monetary amount and allocate that monetary amount to its employees, and then place the responsibility on individual employees to procure or purchase their individual health care or medical insurance plan or policy and any family or dependent health care or medical insurance they may care to obtain, using any available source platform for such insurance. Advantageously, embodiments of the invention provide a facility for the individual employee (or an agent acting for that individual employee) to investigate, gather information relative to coverage, costs, features, suitability and/or other factors, and make a purchase decision on-line over the Internet or other network or interconnected set of computer, servers, information appliances or the like. Embodiments of the invention may advantageously provide for an on-line web based system that is substantially or completely paperless.

In one non-limiting embodiment, the health or medical insurance may be procured from such sources as eHealthInsurance®, insurance.com, and/or other on-line or Internet based insurance sources that are available now or that may become available from time to time now and in the future. In one non-limiting embodiment, individual health or medical care insurance may be procured from non-on-line or non-Internet sources, such as from traditional brick-and-mortar business or via conventional insurance brokers, but these sources are less advantageous as they may not provide the best rates, may have greater administrative burden and costs, and may be more difficult and less efficient for an individual to procure without considerable effort.

In one non-limiting embodiment, the monetary amount may be allocated or deposited to the account on any basis. In non-limiting embodiments, that allocation or deposit may be made on a monthly time basis, on an annual basis, or on any other periodic or non-periodic basis. In one non-limiting embodiment the timing of the deposits may be agreed to between the employer and the employee, or determined solely by the employer, or made on other basis so long as such basis is consistent with applicable local, state, and federal law. In embodiments in which the monetary amounts are pre-funded (or nominal) by the employer and in which an actual dollar or cash value is deposited in the account, a periodic monthly deposit or transaction into the account may be preferred so that amounts in excess of that due to the employee would not have been paid to the account if the employer-employee relationship is terminated. A monthly or 30-day basis is also consistent with the coverage periods of many health care or medical insurance coverage periods. In at least one non-limiting embodiment, the amount deposited may be between about $100/month and $1000/month per employee. In another non-limiting embodiment, the amount deposited may be between $200/month and $500/month per employee. These monetary amounts are merely used for the purpose of explanation and are not limits of the invention. They may be higher or lower and one may reasonably expect the typical amounts to change over time even if only in response to economic inflation pressures and/or cost-of-living changes. It may be appreciated that the amount deposited on a per employee basis is made to a particular employee account that will be owned and controlled by that employee (or optionally by an agent selected by the employee) and that the amount deposited may be more than, less than, or about equal to the actual costs of the health or medical insurance that will be selected and procured by the employee.

It may be emphasized that in at least one embodiment, the responsibility for selecting, procuring, and paying for the individual health or medical insurance is on the employee and not on the employer. The individual employee takes the money from the employee account, finds the health or medical insurance that the employee finds suitable for their (and optionally for their family and/or dependents) needs, applies for the insurance including supplying any personal information, and then pays for the insurance. In one non-limiting embodiment, the employer may assist in or facilitate the transfer of payments from the employee account to the insurer for the convenience of the employee.

It may be appreciated that in at least one non-limiting embodiment, the inventive financial product and service is a nominal presently funded account and not a notional account which is not presently funded with a cash amount. Nominal accounts are pre-funded with an actual cash value and deposit or an equivalent of cash. By comparison, notional accounts are not pre-funded by the employer and for notional accounts the notional amount may not actually be exchanged or deposited, rather such notional accounts may represent a future liability. Conventional flexible spending accounts, health reimbursement arrangements, and other known conventional financial products in the health and medical care or insurance field are notional and not pre-funded by the employer.

In one non-limiting embodiment, the employee may also optionally contribute money to the account from which they may fund or pay for health or medical care expenses. They may for example, use the employer or optional employee contributions for payments that are below a health insurance deductible amount, to pay for expenses that may not be covered by their selected health insurance plan, to pay for any health or medical care co-payments that may be required by the selected health insurance plan, or for other purposes.

Therefore, in one aspect the invention provides a novel and unique system, method, business model and method, and financial and health care product that pairs the procurement of an individual (and optionally family and dependent) health insurance product with an account-based nominal financial product. Advantageously, embodiments of the invention provide that the plan is a defined contribution plan rather than a defined benefit plan. Advantageously, embodiments of the invention provide that the health or medical insurance is procured and funded in a tax-advantaged manner using a tax-advantaged financial mechanism and vehicle.

Although notional financial products may be less advantageous than nominal financial products, embodiments of the invention do not preclude providing notional (or non-pre-funded) product or plan components instead of, or in additional to, nominal (or pre-funded) product or plan components, though nominal or pre-funded accounts have clear advantages, and may advantageously be available at least as a component of the plan. Furthermore, although defined benefit products and accounts may be somewhat less advantageous in certain respects than defined contribution products or accounts, embodiments of the invention do not preclude providing defined benefit components instead of or in additional to defined contribution components.

Under many traditional defined benefit health care plans, an employer provides its employees with a defined health care benefit that may typically include doctor visits, hospitalization, pharmacy or prescription drug benefits, and the like, and at an uncertain monthly or annual cost. Year over year costs may also be uncertain. Under a defined contribution health care plan, the employer provides its employees with an allowance or “contribution” (possibly tax-free or partially tax-free) to spend on their own health care, and at an annual cost that the employer can know in advance and control. In fact, the employer contribution may advantageously be fixed so it is completely predictable, known in advance, and controlled. Employees use this allowance to pay the premiums for their own individual/family health insurance policy, to pay out-of-pocket health care and/or medical expenses, and where applicable to make contributions to a Health Savings Account.

Embodiments of the invention provide a novel financial account that supports and services other aspects of the invention. This account is referred to for convenience as a Health Expense Account (HEA). This HEA may be used as the account into which the employer deposits the pre-funded employer health or medical employee contribution and out of which the employee pays for their individual health insurance payment or premium. This HEA may also be used to fund a Health Savings Account (HSA) or where permitted an HSA-like account. This account and/or any optional sub-accounts, may be used by the employee to contribute or deposit monetary amounts separate from employer contributions. The account assets from whatever source (employer, employee, or other sources) may then be used to pay for health or medical care related expenses. These expenses may by way of example, but not limitation, include one or more of: insurance payments or periodic (for example, monthly) premiums, doctor bills, chiropractic bills, dental bills, ophthalmic or optical examinations, eye glasses and/or contact lenses, co-payments, insurance deductible amounts, prescription drugs, over-the-counter medications, or other health or medical care related products or services. It may be appreciated that some of these items may receive tax-preferred treatment while others may not. Ultimately it is the account holder's responsibility to understand which expenses may be income tax deductible expenses or otherwise receive favorable tax treatment. Embodiments of the invention may provide guidance to the employee account holder as to what categories or expenses or even which particular expenses may be tax-deductible or otherwise receive tax-advantaged treatment. Although embodiments of the invention may provide some guidance as to tax treatment of certain categories of expenses, the inventive system and method do not attempt to provide individual tax advice or tax treatment opinions.

The HEA is not or may not be a completely tax-advantaged health related account in the way a federally recognized HSA is. However, embodiments of the inventive HEA may include funding for an HSA as described elsewhere herein and other tax-advantaged accounts. It may be appreciated that embodiments of the HEA are not intended to be a completely tax-advantaged account itself; rather some of the funds from it may be used in a tax-advantaged manner.

Although not all funds deposited into or withdrawn from the HEA may receive tax-advantaged treatment or even tax-deductible status, intelligent identification of fund sources and fund amounts and prudent allocation of funds to health or medical care expenses may provide employers and employees (including former employees that have funds in a HEA that was established when the individual was an employee) with the same, substantially the same, or even better health and medical care benefits than may be available with federally recognized HSA accounts alone.

In the inventive HEA structure alone or in conjunction with the underlying HEA framework, a loose financial vehicle is established that may be able to fund a federally qualified High Deductible Health Plan (HDHP) as well as a federally qualified HSA and/or other federally qualified plans, programs, or accounts. Neither the HDHP nor the federally qualified HSA need be employer provided, sponsored, approved, or recognized.

The inventive HEA may therefore be used not only to fund an HDHP and HSA, but also to be able to ubiquitously and legitimately fund may other health and/or medically related expenses as are known and/or as are described elsewhere herein. For example, these expenses may be not tax-advantaged or not deductible under the federally recognized HSA. The funds received into the HEA account to the employee may be before-tax or after-tax, as may contributions to a federally recognized HSA. The burden of identifying tax-deductible versus non-tax-deductible account allocation options for payment from the HEA account may be placed on the account holder and not on others. Advantageously, the account holder will optimize contributions to the account and withdrawals or allocations of funds from the HEA account to substantially maximize or optimize their total benefit. Non-limiting embodiments of the invention advantageously provide an accounting or allocation system and method that guide the account holder in making allocation decisions. Reporting features may also be optionally but advantageously included. Optional, post-allocation accounting and tax-preparation and reporting features may further advantageously guide the account holder in tax planning. Non-limiting embodiments of the invention may also provide for some post-expenditure reallocation of the funds in the event that an expense was inadvertently allocated to or debited from the account which should not have been, and for which there may be a negative tax implication or penalty.

In addition to the HEA account structure, embodiments of the invention may include a system that supports the HEA account structure and features and capabilities associated with the account structure. In one non-limiting embodiment, the invention provides a workflow-based system that incorporates employer-based employee payroll processing to provide the transfer of the employee health or medical benefit from the employer to the employee HEA account. This employer-based employee payroll processing may be performed directly by the employer or through a third-party associated with or contracted by the employer to perform this payroll processing.

Embodiments of the inventive system and method may further advantageously but optionally include features and interfaces for interacting with and/or plugging into one or more of: an insurance plan or policy procurement by the individual, contribution of and/or allocation of contributed funds for tax-advantaged treatment and/or for non-tax-advantaged treatment, and/or for interaction or contribution of and/or allocation of contributed funds for a multitude or other accounts that may relate or pertain to health and or medical related expenses. Non-limiting embodiments of the invention may optionally include features that tie into or communicate with tax-preparation software programs such as for example with the TurboTax® tax preparation software programs, and/or with business or home financial accounting software programs such as for example one of the commercial financial software programs made by Quicken®.

These other accounts may include or be selected from debit cards, smart cards, or other financial tokens and/or identifiers issued to or associated with the employee or individual HEA account so as to facilitate allocation or transfer of funds from the account, such as when the account holder visits a health care provider office (for example, a doctor office visit, a chiropractic provider office or clinic), purchasing prescription medications from a pharmacy either in-person or on-line, or for any other product or service that may pertain to health or medical treatment. Optionally but advantageously, guidance may be provided to the account holder as to possible or probable tax treatment or deductibility status of a service or good. This guidance may be provided at a point of service, treatment, or purchase.

Embodiments of the invention further provide a funding mechanism for employees that supports employer and employee needs for funding the HEA account, providing method and mechanism for the individual employee to sweep, move, or otherwise allocate money or assets from the HEA account to another recipient (such as for example, to a federally approved HSA) so as to be able to fund one or more tax-advantaged accounts, to pay bills, and the like. Embodiments of the invention therefore may advantageously provide an entire employee or consumer portal associated with the consumer selection, procurement, and management of HEA account funds. Embodiments of the invention may also advantageously provide an employer or provider portal associated with the employer management of HEA account funds and workflow associated with the deposit of these funds in to each employee account.

The inventive Health Expense Account or HEA account is different from conventional health care related accounts at least in that the inventive HEA does not require an individual (optionally including family members and/or dependents) to have an HDHP, though it does not preclude the HEA holder from having one and reaping additional benefits by having the HDHP. On the contrary, the inventive HEA account structure, and associated system and method permit an individual (and any family and/or dependents) to achieve some or all of the benefits of these conventional HDHPs. A significant further advantage is that the employee may have the HEA and fund their own individual purchase of an HDHP from the funds deposited in the HEA and when an HDHP has been obtained, to also fund a conventional and tax-advantaged HSA.

The inventive HEA account, system, and method provide an environment and mechanism in which the employer provides a health or medical insurance benefit to an individual employee (with optional extension or additional benefit to that employee's family member or dependents) so that the employee is empowered to take that benefit, usually in the form of a prior monetary deposit or payment into the individual employee's account, so that the individual employee may procure or purchase their own health or medical insurance plan or policy. The individual employee may then select and purchase their health insurance plan or policy, which may advantageously be a qualified HDHP or a health plan that has some, most, or all of the features and advantages of a qualified HDHP. In addition to selecting and individually procuring a health or medical insurance plan or policy, the individual may advantageously also establish an ancillary HSA when the requirements for establishing such health savings account are met. Presently, establishing a formal HSA requires that the individual also have an HDHP.

In one non-limiting embodiment of the invention, the HEA is established on behalf of an individual employee (and optionally for the individual employee's family and/or dependents). The individual employee, or other entity or agent acting with authorization for the individual employee, may self select his/her custodial banking or financial institution. The custodial banking or financial institution is the institution where the HEA account is established and the money or funds in the account are deposited and maintained. In one embodiment, the individual employee may select an arbitrary custodial banking or financial institution. In another embodiment, the list of permitted custodial banking or financial institutions is pre-screened or pre-filtered so that the individual employee is presented with a more limited list of custodial banking or financial institutions and makes a selection from this list. In one embodiment, the prescreening or prefiltering may be performed by the account services provider, such as by Canopy Financial®, or by other participant providing the services. In yet another embodiment, the individual employee may request that a particular custodial banking or financial institution that is not in the list be considered and added to the list.

The Health Expense Account (HEA) is an account that has a different structure and function than other accounts that may be encountered in the health care field or associated health care services or financial services industries. The HEA for example, is different from an HSA. The HEA account may co-exist with other financial vehicles or structures, including for example with conventional HSAs.

In one aspect, embodiments of the invention advantageously provide a method for pairing or combining a conventional HSA with a mechanism for procuring individual health insurance (optionally with family or dependent health insurance coverage). The inventive HEA account structure and associated system and method may apply to a plurality of individual insured members (for example, to the employee and his/her family and dependents) but is distinguished from conventional employer sponsored or provided group health insurance policies at least because the individual may procure health insurance outside of any group plan, and no group participation is expected and none may be available. The inventive HEA account structure, system, and method may advantageously provide for seamlessly combining individual employee health insurance and an HSA.

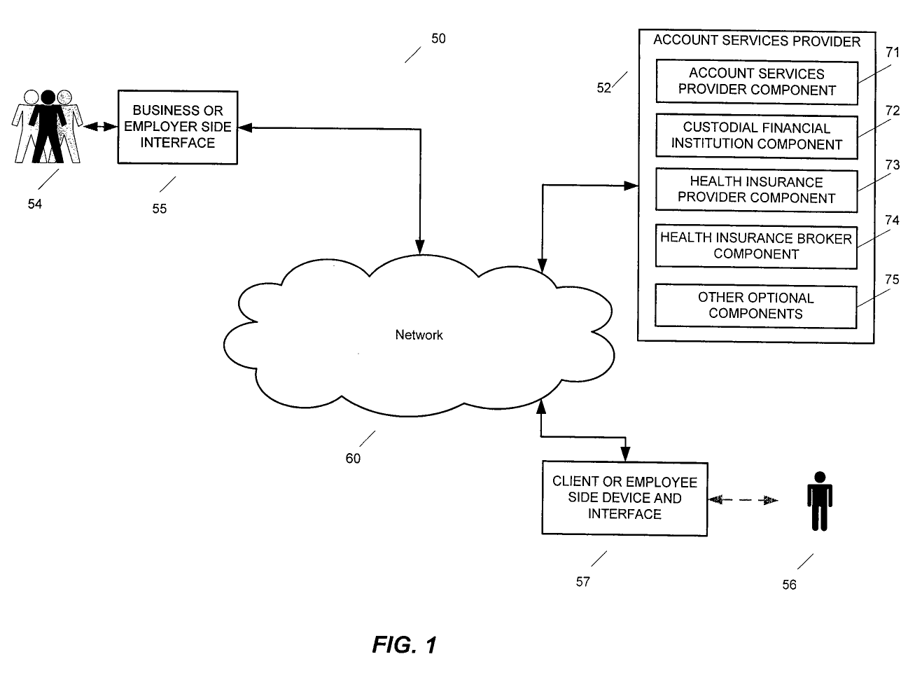

With reference to FIG. 1, one simple but exemplary embodiment of the system 50 may include a service provider 52 that provides the health insurance plan and insurance coverage, that may also provide any health insurance brokerage services that may be needed or desired, that provides custodial financial or banking services to maintain the individual HEA and hold the deposit of the money or funds in that account, and that acts as the account services provider including providing account management, coordination, recordkeeping, and maintenance of employer and employee portals and web content. In this exemplary embodiment, much of the system functionality other than that of the business or employer and of the employee is handled by a single entity. A system where multiple entities provide component functionality would be more typical and perhaps more efficient, and such as system is described in greater detail below.

The account service provider 52 interacts with one or more businesses or employers 54 through a business or employer side interface 55 and one or more individual employees 56 (which may include former employees) through a client or employee side interface 57 over an interconnected network 60 (e.g. the Internet) of computers, servers, information appliances and the like to collect input information and data and to provide output information and data to the employers and/or employees. The employer side interface 55 and client side interface 57 may be provided through respective employer side and client side computer or information appliance.

In this embodiment of the account services provider 52, multiple functional components are integrated into and provided by the account services provider. In this non-limiting embodiment, they include: a specific account services provider component 71, a custodial financial institution component 72, a health insurance provider component 73, an optional health insurance broker component 74, and possibly other optional components 75. The functions and operations provided by each of these entities and the data and information exchanged among and between the identities are further described in additional detail below, after describing some alternative embodiments of this system.

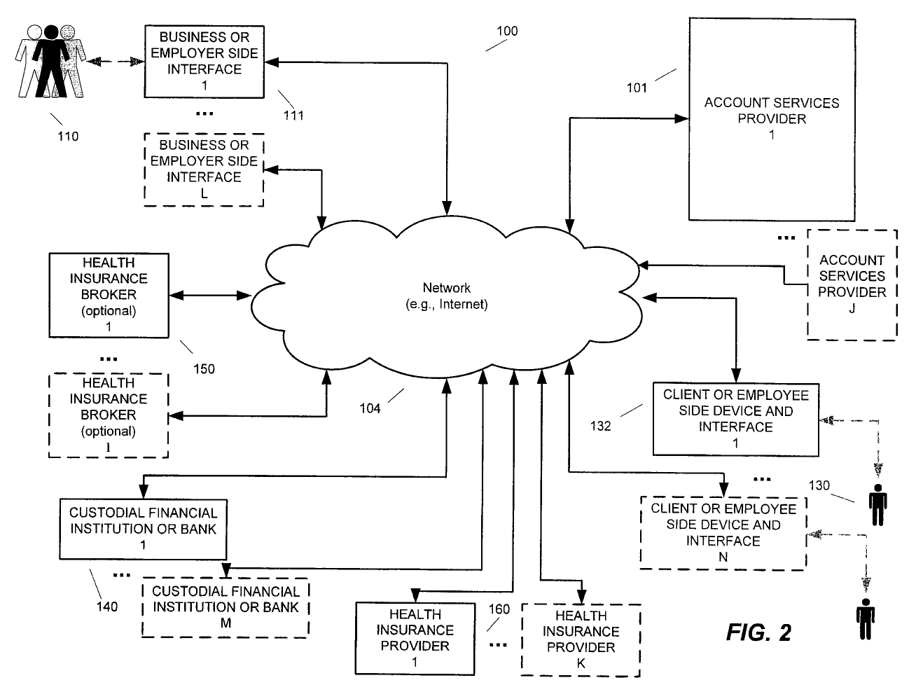

FIG. 2 illustrates an alternative system 100 embodiment in which the functions, operations, and responsibilities of the account services provider 52 of the FIG. 1 embodiment are now distributed among a plurality of separate entities. The account services provider component 71 of the FIG. 1 embodiment is provided by account services provider 101 in the embodiment of FIG. 2. Furthermore, separate entities are identified for: the health insurance plan and insurance coverage provider or company 160, the optional health insurance broker and brokerage services 150, and the custodial financial or banking services 140. These entities may be connected together using any available communications link or links, but such communication links may advantageously be electronic data and information links over a network such as over the Internet network 104. Advantageously, security features are implemented to protect sensitive information.

One, or more typically, a plurality of businesses (also referred to herein as employers) 110 are also connected (perhaps intermittently) for communication with at least some of the other system entities over the network 104 usually using a computer or other information appliance providing a business or employer side interface 111. In non-limiting embodiments of the invention, a human resource manager, personnel manager, business owner, or other individual tasked with interacting with the system will be involved in registering the business or employer with the inventive service and with providing an initial upload of employee and benefit information, and with possible future periodic updates to that information as described in greater detail herein after.

One, or more typically, a plurality of individuals (also referred to herein as employees, former employees, or consumers) 130 are also connected (perhaps intermittently) for communication with at least some of the other system entities over the network 104 usually using a client-side or employee-side device or access information appliance and interface 132. In non-limiting embodiments of the invention, the individual employee will interact with the system 100 to complete the individual employee registration and to provide employee information that will validate the individual employee to the system and to an account established for individual employee on the system, and to permit the individual employee to select health and medical insurance coverage options and to designate how money in an account established for them is to be disbursed and managed. These individual employee interactions are described in greater detail hereinafter.

In the exemplary system configuration of FIG. 2, a single account services provider 101 is illustrated that supports one or a plurality of businesses 110 via multiple employer side interfaces 111 (1, . . . , L); optionally using one or a plurality of health insurance brokers 150 (1, . . . , I); using one or a plurality of health insurance providers 160 (1, . . . , K); one or a plurality of custodial financial or banking institutions 140 (1, . . . , M); and supporting one or a plurality of employees 130 via one or a plurality of devices and interfaces 132 (1, . . . , N). It may be appreciated that multiple account services providers may be implemented and provided to service a set of employers and employees, but that typically a single account services provider will provide services for a plurality of different employers and their employees. It may be appreciated that a plurality of account services providers (1, . . . , J) 101 may be provided in a system. Different account services providers if present, may be utilized to service different employers, different groups of employees, to provide service redundancy in the event of a server or partial system failure, and/or to provide additional capacity, and/or different levels of service or branding.

It may be apparent from the exemplary systems 50, 100 of FIG. 1 and FIG. 2 respectively, that there are three primary participants in the interaction. There is a service provider that sends and receives information from businesses/employers and from individuals/employees. The services provided by the service provider may be performed by a single entity, by a single entity having multiple identifiable functional divisions, or by separate entities. In one embodiment, the separate entities are different companies, different corporations, different banks or financial institutions, different health insurance companies, different health insurance brokerage firms or companies, and so forth. Therefore it will be appreciated in light of the description provided here that various different groupings or configurations may be utilized to provide the described services, account structures, health care product, and financial product. It may also be appreciated that various different business methods may be contemplated with interaction and revenue passing between different pairs or other combinations of involved entities. Furthermore, the business/employer entity (but not the human element) and/or the individual/employee (but not the human element) entity may in some embodiments be considered to be a system component, and in other embodiments they are external sources of information and destinations for data and therefore separate from the system itself. Similarly, various different system configurations may be contemplated by the invention, such that by way of example and not by way of limitation, particular system configurations may not include a health insurance broker component 150. It will be apparent that the inventive system may take a form that is intermediate between that of the FIG. 1 embodiment and the FIG. 2 embodiment, at least relative to the distribution of functions and responsibilities.

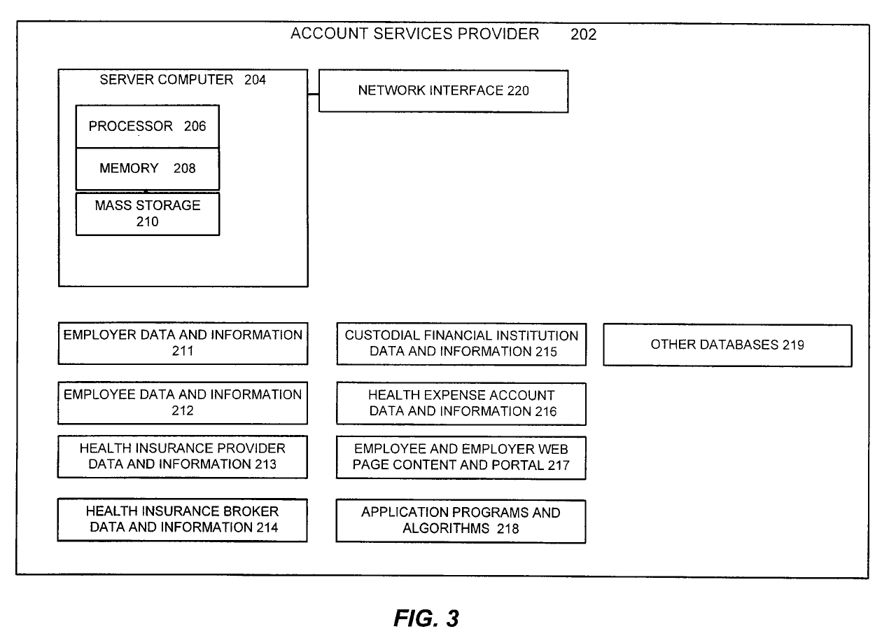

With reference to the embodiment illustrated in FIG. 3, there is illustrated an exemplary embodiment of an Account Services Provider 202 which may be a particular embodiment of the account services provider 52 in the embodiment of FIG. 1 or of the account services provider 101 in the embodiment of FIG. 2. Account services provider 202 may include a server computer 204 that has a processor 206 and memory 208 coupled to the processor 206. The server computer 204 may also include one or more mass storage devices such as one or a plurality of hard disk drives 210 for storing employer data and/or information 211, employee data and/or information 212, health insurance provider data and/or information 213, health insurance broker data and/or information 214, custodial bank or financial institutions data and/or information 215, health expense account data and/or information 216, employer and employee based web pages and content 217, algorithms and computer programs for providing various accounting, sub-accounting, and/or reporting features 218, and/or optionally other data or databases 219 to provide the content and services described elsewhere herein. A network interface 220 is also provided for the server computer 204 so that the account services provider 202 can communicate or network with other components of the system 50, 100. Various application programs may be executed on the server computer to effectuate the methods and operations described here. The other functional entities identified in the exemplary systems 50, 100 of FIG. 1 and FIG. 2 may also include computers having processors, memory, and storage to execute application programs to effectuate the methodological and functions attributed to them and described herein.

The participation of the various entities identified in the system 100 of FIG. 2, especially the participation of the custodial bank or financial institution 140, the health insurance plan or policy provider 160, any optional health insurance broker 150 that may participate, and the account services provider 101 (which may be implemented as the account services provider 202 in FIG. 3), provide various possible revenue or monetization strategies that may underlay embodiments of an inventive business method and business model. Non-limiting embodiments of the business method and business model may also include business models or methods that derive from either or both of the business/employer and individual/employee interactions with other entities. Each different interaction between any two or more of, for example, the custodial bank or financial institution 140, the health insurance plan or policy provider 160, the health insurance broker 150, the account service provider 101, the business/employer and individual/employee, may present an opportunity for revenue and profit generation.

With respect to the inventive business model and business method, monetization and revenue generation may be predicated on several possible schemes that may be applied separately or in any combination. For example, embodiments of the inventive business method, system, method, account structure, and financial and health care product and service may be sold or licensed to financial institutions, health insurance brokers, health insurance plan providers, and/or potential account service providers. The products and services may then be offered out to their current or future member bases. In one non-limiting embodiment, the account service provider may be Canopy Financial® (the assignee of the present invention), who will provide the products and services described herein. In another non-limiting embodiment, there may be a plurality of licensed or otherwise authorized account service providers that provide the described products and services.

In one embodiment, a revenue model associated with the inventive business method collects a license fee for use of the inventive platform and method. In one embodiment, a per account, per month fee is collected for every account that is put onto the inventive system. In one embodiment, a fee is collected for managing the employee and employer portals and the portal content and for otherwise providing and maintaining the system and its operation. In other embodiments, any of the possible combinations of these fees may be collected. In one embodiment, each of the license fee, the per account per month fee, the fees for providing and maintaining the employer and employee portals, and the fees for providing and maintaining the system and its operation are all collected. Other models may provide revenues for other transaction described herein, or for premium services such as particular reports or accounting, and the like.

Other embodiments of the invention may provide for different distribution of operational responsibilities. For example, and with reference to FIG. 1, a single entity may provide all of the components such as providing the account services provider component 71, the custodial financial institution component 72, the Health Insurance Provider Component 73, the Health Insurance Broker Component 74, and any other optional components 75 that may be useful or desirable, except for those of the business 54 (and the business or employer side device and interface 55) and the employee 56 (and the client or employee side device and interface 57) and the employee's computer or connection terminal. The network 60 will typically be a publicly accessible network such as the Internet.

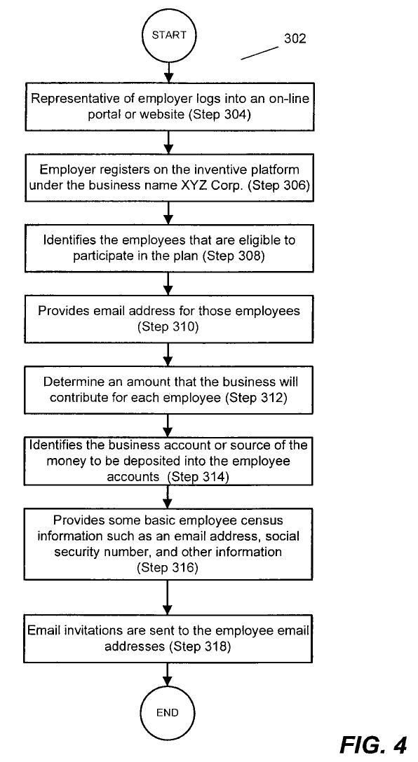

An exemplary non-limiting embodiment of business/employer interaction process during business registration with the service is now described with reference to FIG. 4. During an employer or business enrollment process 302, a representative of the business or employer, such as a human resource manager, logs into an on-line portal or website (Step 304). The business (e.g., “XYZ Corp.”) then registers the business on the inventive platform under the business name XYZ Corp. (Step 306), identifies the number of employees that are eligible to participate in the health care or medical care plan for whom benefits will be provided by the business (Step 308). For example, the business may indicate that there will presently be nine employees. The business will then provide email address (or other contact information) for those employees (Step 310) and identify or determine an amount that the business will contribute for each employee (Step 312).

Typically this amount will be the same for each employee, but embodiments of the invention may provide for allocating different amounts for different employees. These differences, if they exist, may depend on such factors as the employees' position at the business, when they joined the business, negotiations between the employee and the business, and/or if the employee has family or dependents. In one embodiment of the invention, each employee is allocated the same benefit amount under a defined contribution plan and the employee may then procure appropriate health or medical insurance coverage for his/her self and family and/or dependents. Recall that the money is provided by the employer to the employee account but that the money is then under the control of the employee (or by the individual if and when they cease to be an employee of that particular business) so that they may make their own health or medical insurance decisions.

Embodiments of the invention may optionally provide an employee's business electronic mail or email address (if the employee has a business email address (e.g., employeename1@xyzcorp.com) or through an employee personal email address (e.g., employeename1@personalemail.com) if they do not have a business email address. In situations where the employee does not have an email address or does not choose to provide it to the employer or business, alternative traditional paper-based information may be utilized so that the employer/business has an opportunity to provide instructions for allocation and deposit of the benefit amount into an account that is accessible to and under the control of the employee. The administrative burden and therefore the cost of administering the program is reduced when communications, registrations, and transactions are electronic and Internet based so that paperless methods are advantageous. On the other hand, some number of paper-based transactions may be supported so as not to prevent a business from implementing the inventive account structure, system, and method. In the alternative, the business may require each employee to obtain an email address in order to participate or to receive the benefit contribution. (The employer may procure email accounts on behalf of the employee if desired.) In this scenario, even if the employee does not own a computer or other information appliance that would permit access to the consumer/employee portal, that employee may access the portal through a public computer such as may be available at a public library or even a computer or information appliance at the business.

The business continues registration by identifying the business bank account or other source for the money or funds to be deposited into the employee accounts (Step 314). This information may be provided through the employer portal as the input to a form or other input field or query. The employer may also provide some basic employee census information, an email address, social security number, and other information items (Step 316) of the character that are typically needed to uniquely identify the employee, optionally provide a later basis for verification of employee identity when an employee later contacts the platform to designate a destination to which the employer deposited funds may be transferred for health insurance premium payment or for other health or medical care related expenses. Secure communication and transaction processes as are known in the computer and information arts should advantageously be utilized for the communication and transmission of all sensitive information.

In accordance with one non-limiting embodiment of the invention, after the employer completes the employee identification information input (and optionally, more detailed employee census information), email invitations are sent by the system to the employee email addresses that were provided to the employer for that purpose (Step 318). Each employee must then later log into the consumer/employee portal and identify his/her self and provide an employee authentication. Any of the authentication schemes that are known in the art may be utilized for this purpose.

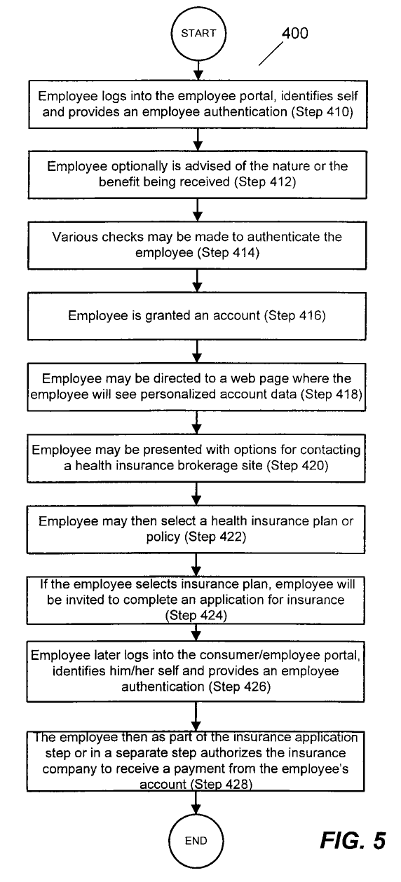

An exemplary non-limiting embodiment of an employee interaction process 400 during initial employee registration that may occur after the employer or business has registered and established an account for the employee is now described with reference to FIG. 5.

While various employee registration schemes may be contemplated and may provide some unique and advantageous features, they are not limitations of the invention. A typical employee registration procedure (that includes a request for opening the employee account) may provide for the employee to log into the consumer/employee portal and identify his/her self and provide an employee authentication, and for example entry the employee social security number (SSN) and for entry of the employee's own user credentials (Step 410). The employee may optionally be advised of the nature or the benefit being received in conformity with any local, state, or federal laws, and such may include an Explanation of Benefits (EOB) statement (Step 412). Optionally but advantageously, various checks may be made to authenticate the employee making the requests for an account to prevent fraud, and these processes may be the same as or include features such as the security measures implemented when a bank or other financial institution is opening an account (Step 414). These security measures may for example include one or more of pulling credit data, verifying an address and determining if the requester has closed a bank account or had a bank account closed, may include checking check watch list databases, and items of that nature. These security features are designed to protect both the assets of the employer that are deposited as well as those of the employee, so that the proper employee receives and has access to the deposited benefit funds.

After employee registration and authentication, and any optional security measures are satisfied, the employee is granted an account (Step 416). At this stage, the employee may be directed to a web page (such as a home web page identified with that employee's account) where the employee will see personalized account data (Step 418), including for example a current funds balance in the account, a list of transactions including any deposits made into the account by the employer, and optionally any additional information related to the account.

Once the registration and authentication have been completed, the employee may be presented with options for contacting a health insurance brokerage site (Step 420). These options may include URL based web site links on the directed to one or more health insurance brokerage websites or directly to a health or medical insurance provider website. The health insurance brokerage site or sites are advantageous because they provide information and an opportunity for the employee to investigate, shop and compare all sorts of health and medical insurance plan options. Non-limiting embodiments of the invention may provide for click-through and/or advertising revenues to be collected from advertising health insurance companies presenting content at these sites.

The employee may then select a health insurance plan or policy (Step 422) or may delay that choice and purchase to a later time. If the employee selects a health or medical insurance plan, the employee will be invited to complete an application for insurance (Step 424). Advantageously, this will be an on-line application process where the employee-applicant will provide the requested information. The employee-applicant will need to provide personal (and possibly family and dependent information) that may be relevant to obtaining insurance coverage, the type of coverage, prior medical conditions, and the like information relevant to insurance coverage and not otherwise prohibited by laws that may be applicable in the employee-applicant residence or domicile. If the application is successful, the health or medical insurance policy premium will be paid for out of the employee account established earlier.

The employee may then be accepted for the selected insurance plan either immediately on-line or after any optional consideration of the application or investigation or verification of information (Step 426). The employee may then as part of the insurance application step, or in a separate step, authorize the insurance company to receive a payment from the employee's account (Step 428).

Optionally, but advantageously at least some embodiments of the invention provide for the passing of secure tokens or metadata or other identification indicia so that the amount of data or information input by the employee to identify their account is minimized.

In one non-limiting embodiment, the money or funds associated with the individual employee benefit account have been deposited in the custodial financial institution that has been selected by either the employer (where there may be an employer choice), or in a custodial financial institution selected by the entity that is offering the service, or in a custodial financial institution selected by the account services provider. In one non-limiting embodiment, the account services provider may be Canopy Financial® of 201 Spear Street, Suite 1600, San Francisco, Calif. (the assignee of this invention, patent application and patent).

As described herein elsewhere, the individual is invited to shop and identify the health or medical insurance options available to them. The employee may then select a health or medical insurance plan or policy, and proceed through the insurance plan or policy application process just like he/she normally would in conventional situations.

At the time the applicant is required to make an insurance policy deposit or pay an insurance policy premium, the money for that deposit or premium is pulled or transferred from that individual's account. The employee selected health insurance plan may be any plan he/she is able to identify that meets their need. Advantageously, the employee will be able to identify and select a health insurance plan or policy that qualifies as a HDHP, possibly with various health plan options. Advantageously, the health plan options may include a HSA option. The HDHP is their own and need not be one selected or sponsored by the employer. If there are any funds remaining in the employee HEA account, it may be swept out of the HEA account and into any HSA account the employee may have established. This permits the employee HEA account holder to again take advantage of all the tax benefits of the federally approved HSA.

Then on a periodic or non-periodic basis, typically on a weekly, bi-weekly, or monthly basis that may be tied to the payroll cycle of the business, the employer deposits or transfers funds into the employee HEA accounts. The employee may optionally be sent an alert by the custodial financial institution, that their employer contribution is now available, so that the health insurance premium may be paid from the funds in the HEA account, if they would like. Again, since in at least some non-limiting embodiments of the invention the decision to procure and maintain health insurance is entirely at the discretion of the employee, neither the employer nor the custodial financial institution, nor even the account services manager, may be authorized to make the payment.

In some non-limiting embodiments, the employer may be authorized to either direct payment of the employee's individual insurance premium payment from the employee's HEA account, or to actually pay the insurance premium on the employee's behalf rather than making the deposit of that payment amount into the employee's HEA. When the employer or business has been directed or authorized to pay the premium, the employer business may not ever actually give the employee the money or make the deposit into the HEA, rather the payment amount may be paid or transferred to the employee's selected health insurance provider. This payment may optionally but advantageously be made on a pretax basis as an IRS Section 125 (or other) benefit deduction. The individual also has the ability to put money in that HEA account his/her self on a post-tax basis. It may therefore be appreciated in light of the description provided here that there are multiple different options available in terms of how the health insurance premium is to be paid, and advantageously, payment actions may have or preserve tax-advantaged treatment.

In embodiments in which the employer or business pays the health or medical insurance premium on behalf of the employee, it will be understood that the payment amount should be less than the health care benefit to be provided to the employee. If the premium amount is greater, then it may be necessary for the employee to authorize additional payroll deductions. In addition, if the health insurance premium is less than the health care benefit to which the employee is entitled, then any excess of the required premium payment may be deposited in or transferred to the employee's HEA.

As an option in connection with the custodial bank or financial institution in which the employee HEA account is established, the employee may optionally but advantageously be issued debit or credit financial instrument or token, such as a debit card, smart card, proprietary identification card, Visa® card, MasterCard® card or other financial device or instrument identified to the employee's HEA and adapted for use with that account. These financial instruments or tokens may be used to procure or purchase health or medical care products and services. For example, they may be used at a brick-and-mortar or on-line pharmacy or store for prescription medications and possibly for over-the-counter medications and supplies. They may also be used for payments to doctors, chiropractic offices, or to pay for other health care or medical services, possibly including co-payments that might be required at the time the employee or a covered family member or dependent receives a health or medical care service.

It may be appreciated that such financial instruments and tokens as credit and debit cards are regulated, and that the features and capabilities identified in connection with the provision and use of such financial instruments and tokens is intended to be consistent with such regulations. Although various options are available, it should be appreciated that ultimately the financial instruments or tokens are underwritten by and ultimately matched by or to the custodial financial institution or bank that has been established and is associated with the employee HEA account. In at least one non-limiting embodiment, the financial instrument or token, such as a credit or debit card, is issued to and matched with the account service provider such as Canopy Financial® of 201 Spear Street, Suite 1600, San Francisco, Calif. (the assignee of this invention, patent application and patent). The issuer, if different from the custodial bank that the funds are held at, must have the appropriate legal and infrastructural support in place, and in issuing such instruments may be at risk for those funds until they are settled overnight with whatever bank those funds are actually held at. Generally, the name of the issuer and any bank or financial institution branding should be displayed. The financial instrument, may, for example be branded by a bank or other financial institution, by the employer, by the account service provider such as by Canopy Financial®, or by another institution.

While initial registration by the employer/business and employee/consumer has been described, it may also be appreciated that the inventive system and method supports updates, changes, and other maintenance and management. The entire process may for example be managed on behalf of the individual employee so at any point in time, the individual employee may add dependents, change his/her current address or geographic information if they have moved, and contact information. The portal may be an entirely self-serving and full support portal.

Description here has somewhat focused on establishing accounts, initial registration, and the like. It will be apparent to those workers having ordinary skill in the art in light of the description provided here, that the various parties and entities participating in the inventive system and methods may access the system and utilize aspects of the method to perform updates, to make changes, and to interact with the system. For example, employers may add additional (or delete) employees using the employer portal as new employees join (or leave) the company. Employees may access the system after initial registration to change their choices, including for example to select and choose a different insurance provider or to choose a different insurance plan. Likewise, insurance companies may alter the plans they offer, and so forth.

Having now described exemplary embodiments of the interaction between the employer and the system and between the employee and the system, we turn our attention to the interaction with the custodial bank or other custodial financial institution that holds the employee money or funds in their HEA account. Although the system provides for a custodial financial institution or bank involvement, the interaction with the bank is fairly minimal. It may be appreciated that, the custodial financial institution or bank provides place to establish the HEA (possibly including an HSA component) and then mechanisms for transferring money into and withdrawing money from the account. The custodial bank or financial institution is really providing the actual monetary structure to hold the accounts.

In one non-limiting embodiment, one or a series of omnibus accounts, which are a form of singular bank account are set-up or established with a banking institution. Advantageously, these banking institutions will be large and prominent U.S. banking institutions to provide both efficiencies associated with a large number of employee accounts as well as with high dollar value, and stability and trust; however, the invention is not limited to any particular custodial banks or financial institutions. Advantageously, the accounts established on behalf of the employees will typically be interest bearing accounts.

Advantageously, the system and method provide for optional sub-accounting associated with these accounts. Co-pending patent application Ser. No. ______ entitled SUB-ACCOUNTING FOR AN OMNIBUS ACCOUNT naming inventors Jeremy J. Blackburn, Vikram A. Kashyap, and Anthony Banas and filed 13 Aug. 2007, describes certain sub accounting structures, systems and methods that may optionally but advantageously be used in conjunction with the inventive system, method, health care and financial products described herein.

Non-limiting embodiments of the inventive account, system, and method manages all the Automated Clearing House (ACH) money in, ACH money out, so all of the overnight settlement occurs through the federal funds network.

Advantageously, the custodial banks or financial institutions holding the HEA accounts have very little cost or risk associated with participation and therefore they are presented with a very positive economic incentive to participate. They have little or no deposit acquisition expense, and they have no or substantially no service expense. Employees may be given a choice of which of several banks or financial institutions should be used to establish the HEA account, or it may be selected for them. The accounts may pay interest commensurate with industry norms. For example, at the time of filing of this patent application in 2007, Annual Percentage Yield (APY) interest rates may be on the order of 2% to about 6%, but these are not limitations of the invention, and even non-interest bearing accounts may be utilized, such as non-FDIC insured money market accounts. Some custodial banks or financial institutions may levy fees on their accounts and some may have no fees on the accounts. The custodial banks therefore have a number of options for negotiating interest rates and/or fees to mitigate any risk and to provide a mechanism and source for profit from these HEA accounts.

Returning now to the system as a whole, an optional expense-tracking tool is advantageously made available to the individual employee by the account services provider 52, 101 so that the individual employee can see what they are spending HEA account money on (on a monthly or other basis), how much of their account value is going to insurance premiums versus prescription medicine versus medical goods versus other expenditures. This tool may also provide a set of reporting capabilities that the individual has, as well as fiscal, tax, or calendar year reporting capabilities. The tool may be provided as software executing on a server and accessible through the employee portal or in other ways.

In one embodiment, the inventive system and method provides a year end tax reporting tool or capability wherein the system or component of the system such as the accounting service provider, prepares and optionally files all the tax reporting on behalf of the employee holding the HEA account. All necessary IRS forms may be generated for the individual to file, as well as for the employer to file, and forms for the financial institution to file with the government. The inventive system and method therefore provide a complete integrated analysis and reporting package for the account.

As described herein elsewhere, the HEA account is owned by the employee (or to the former employee if the employee terminates employment either voluntarily or non-voluntarily). It will be appreciated from the description provided that the inventive HEA is portable and may follow the employee and go from employer to employer, and that the services provided may continue even after a voluntary or involuntary severance of the relationship between the employer and the employee.

If the termination is as a result of the employee being fired as a non-voluntary termination, the termination severs the economic relationship between the employer and the individual for subsidizing the health insurance premium, but the former employee is still responsible for paying their health insurance company for the monthly premium because the employee is ultimately the party that is getting the health insurance direct from the health insurance company. The severance process can be done by the individual or by the employer. Advantageously it would be done by the former employee so that there will be no surprise associated with termination of health insurance and so that the former employee may maintain the health insurance if desired without the payment of the former benefit amount into the HEA account. The former employee may advantageously be given notice of the termination of the benefit at the time the employee is terminated.

If the termination from employment is at the choice of the employee, similar procedures may apply. The former employee may continue to access any remaining funds in his/her account and any unused funds in the employee's HEA may be refunded directly to the former employee and optionally swapped back on-line to another employee account, such as for example the employee's savings or checking account, or other destination for the money.

In either situation, the HEA account structure is empowering for the employee participant. The employee is able make independent choices regarding the insurance policy, management of funds, whether to opt-in or opt-out, and the portability of the HEA independent of employer or employment status.

Optionally but advantageously, at least one embodiment of the invention associates awards or points on those accounts for certain types of health care or medical expenditures from the HEA account. These types of award, point or other use of loyalty-based programs are not heretofore known in the banking industry, and more particularly not known relative to health or medical care. For example, an HEA account holder might earn points that could be used at a brick-and-mortar or on-line pharmacy or drugstore, such as drugstore.com for example for certain types of health care and medical expenses. By way of example, but not of limitation, discounts for certain medical providers, chiropractic care, dental, or orthodontia may be provided.

It may be appreciated in light of the description provided herein that in addition to the account structure, the system and method supporting the HEA account, and the business method and model associated with use of the account and generation of revenues, the invention also provides a financial product that is useful and profitable for banks and other financial institutions as well as a health benefit product that is useful for insurance companies, insurance brokers, and ultimately for the business/employer as well as for employees.

Although the above description has focused attention on the individual nature of the HEA account and placed an emphasis on the procurement of individual health or medical care insurance by an employee, there are some what might be considered as hybrid models that may involve a group health insurance aspect, though still different than conventional employer sponsored group insurance programs. In other words, Non-Group Insurance Accounts (NGIAs) may not always be required. In one embodiment of the invention, an insurance product (for example, either an individual insurance policy, or a group insurance policy) is paired or combined with a financial product (for example, an HEA that may optionally include or provide for an HSA if the insurance product is or includes a qualifying HDHP).

In one non-limiting embodiment, the employee may be provided with an option for selecting any one of: a non-employee sponsored individual insurance plan or policy, an employer sponsored group health or medical insurance policy, a non-employer sponsored group insurance policy (such as one available from a professional association), or a group-insurance policy sponsored by a health insurance broker or offered directly by a health or medical insurance provider. In any of these instances, the employer may still provide the health benefit contribution into the employee's HEA account. In the event that the employee chose a health insurance policy that was sponsored by the employer, the payments may be made through the employer sponsored group insurance just as it would be for any other individual insurance plan or policy.

In addition, while the inventive HEA accounts have significant advantages, embodiment of the invention may provide other account structures that do not have HEA accounts but are otherwise able to take advantage of the features and services offered by at least applicable aspects of the inventive system and method. For example, aspects of the invention support HDHPs that are group sponsored and have an HSA, but do not have a formal HEA account.

Embodiments of the invention provide various methods. It may be appreciated in light of the description provided here that these methods, or portions of the methods, may be provided as computer programs or computer program code having executable computer program instructions and optional data. The method may be embodied or implemented as a computer program product that includes a computer usable or readable medium having computer readable program code embodied in the medium for causing an application program to execute on a computer or other information appliance that typically includes a processor and a processor coupled memory for effecting the method or portions of the method.

It may be appreciated by those workers having ordinary skill in the art in light of the description provided herein, that one of the challenges heretofore has been that one cannot have an HSA unless one has an HDHP. Therefore, for employed individuals that rely on employer sponsored health care, unless the employer provided an option for such an HDHP during an enrollment period, the HSA is not available to the employee.

Embodiments of the inventive HEA account structure, and the supporting system, method, and business method completely removes these HDHP, HSA, and limited annual enrollment period issues. The individual employee may select and contract for an HDHP, and for an HSA, and need not wait for a particular enrollment window (typically 30 day enrollment period at the end of each calendar year) to change or enroll in such plans. Embodiments of the invention also significantly reduce administrative costs associated with administering employer or business sponsored health or medical care insurance. Furthermore, embodiments of the invention permit the employer to know and fix costs and expenses associated with the health insurance benefit they may offer to each employee.

Embodiments of the invention also assist in legally circumventing certain apparent or presumed regulatory limitations. Heretofore, one has not been able to use a conventional HSA to pay for one's insurance premiums, there is no conventional mechanism to do that, and one is penalized for using or attempting to use such HSA funds to pay for health insurance premiums. Embodiments of the invention overcome these and other limitations.

Embodiments of the invention provide a Health Expense Account (HEA) which is different in structure and function from a Health Savings Account (HSA). Embodiments of the invention provide the HEA along side and synergistically paired with the HSA (if there is also a HDHP) and permits one to funnel money through the HEA and then out to the insurance company providing the policy without ultimately affecting the integrity of the HSA or the tax-advantaged status of the HSA so that money can flow into the account (for example, from a separate personal checking account) and still keep the account from being used for items that are not eligible for use and suffering a 10% penalty as a result of using the account for non-eligible expenses.

Attention is now directed to particular exemplary embodiments of the invention and to exemplary interfaces that show the look and feel of the employer and employee interfaces and interactions.

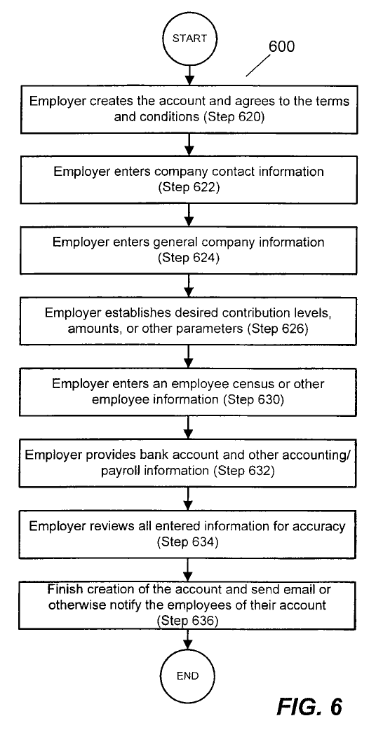

Referring to FIG. 6, there is shown a block diagram illustrating an example use case procedure 600 for setting up an employer account using the employer enrollment. As described elsewhere herein, the various functions and responsibilities provided in the inventive system, methods, and products may be performed by a single entity or divided among a plurality of entities. To begin, in this non-limiting exemplary embodiment, a human resources manager or other representative of a company or employer goes to or accesses the account services provider site, creates the account, as described elsewhere herein, and agrees to the terms and conditions (Step 620). The manager acting for or as the employer may enter company contact information (Step 622), enter general company information (Step 624), and may provide contribution parameters (Step 626), such as desired contribution levels or amounts. The manager then enters an employee census or other employee information (Step 630), provides bank account and other accounting/payroll information (Step 632), and reviews all entered information for accuracy (Step 634). Once reviewed, the system finishes creation of the account, and may send email or otherwise notify the entered employees (Step 636) so they may create their individual accounts and become members of the exchange account.

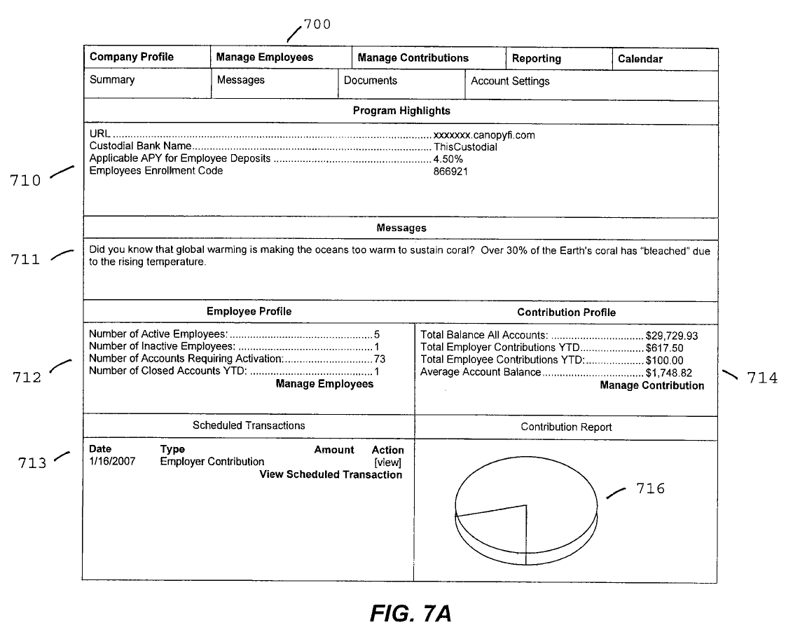

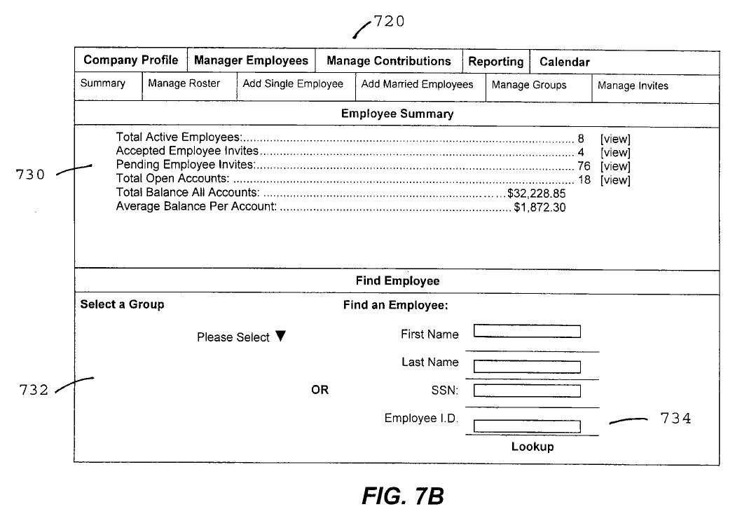

Once the account is set up and the account is ready to receive funds from the business or company, the company may access the account to manage the employees receiving benefits, to review historical or other information, to review payments records, and so on. FIG. 7A and FIG. 7B show example web portal pages or interfaces 700, 720 displayed to employers during account management. FIG. 7A and FIG. 7B are non-limiting exemplary representative computer displays or web pages that may be used with the inventive system and method and in connection with the financial and health care instruments. Other similar or different displays or web pages may alternatively be used. The exemplary web pages or screens of FIG. 7A and FIG. 7B and/or other screens or user interfaces described herein, may be implemented in C++ or as web pages under XML (Extensible Markup Language), HTML (HyperText Markup Language), Flash, or any other scripts or methods of creating displayable data or content, such as the Wireless Access Protocol (“WAP”). The screens or web pages provide facilities to receive input data, such as an electronic form with fields to be filled in, pull-down menus or entries allowing one or more of several options to be selected, buttons, sliders, hypertext links or other known user interface tools for receiving user input. While certain ways of displaying information to users is shown and described with respect to certain figures, those skilled in the relevant art in light of the description provided here will recognize that various other alternatives may be employed. The terms “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats.

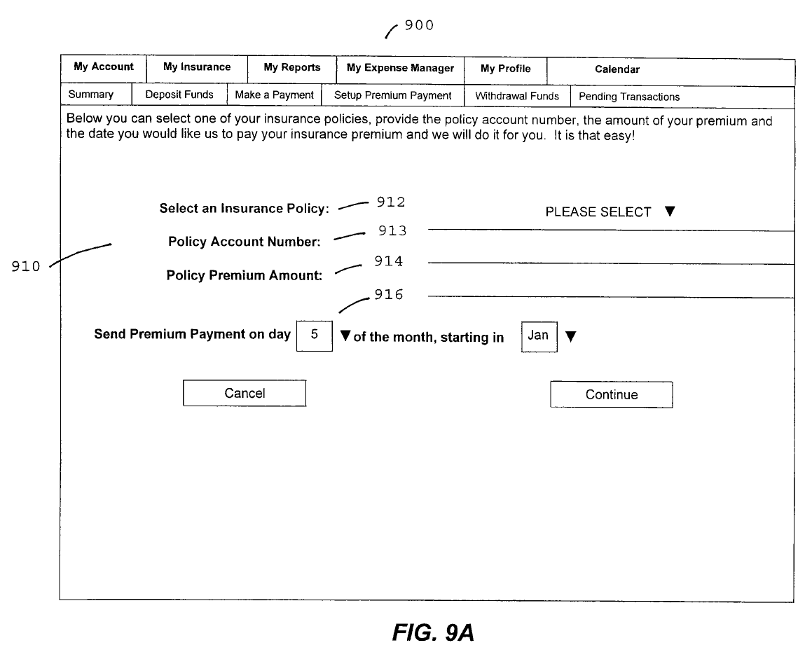

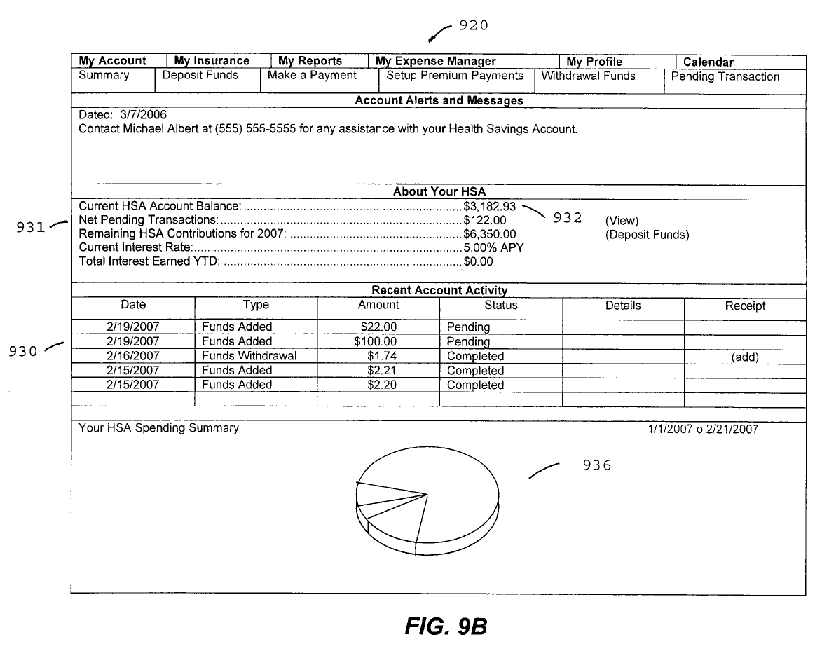

Several exemplary screen shots or displays are represented in FIG. 7 and FIG. 9 to provide an indication of the interfaces that may be used with embodiments of the invention. Due to the restrictions associated with the use of color and different shades of gray in published patents, the web site screen shots and displays have been simplified. It will be understood that such web pages and interfaces may include such features as color, roll-over bars or buttons, hot spots, pull-down menus, and other static or dynamic features as are known in the art.

Referring to FIG. 7A, an example screen 700 related to employer account information management is shown. Screen 700 displays, for example, overall program information and program highlights 710, optional important messages 711, employee profile information 712 related to employees that receive benefits, scheduled transactions information 713, contribution profile or financial or contribution information 714, and so on. In one non-limiting embodiment a graphic 716 may be displayed to graphically or pictorially represent contribution information. Numerical percentage values or monetary amounts may optionally be shown with the graphical information. The screen 700 may contain other elements, such as company branding, financial institution branding, advertising, contact information, help information, and other peripheral information or content. Referring to FIG. 7B, an example screen 720 related to employee management, is shown. Screen 720 displays, for example, overall employee summary information 730, employee selection or search functions 732, employee lookup functions 734, and so on.

Screens 700 and 720 are presented to show example interfaces for use with the system. Although not discussed, other aspects of the system may be presented to users via similar or even different user interfaces, web pages, or portals, such as those discussed herein or other aspects typical of account management and/or financial management systems.

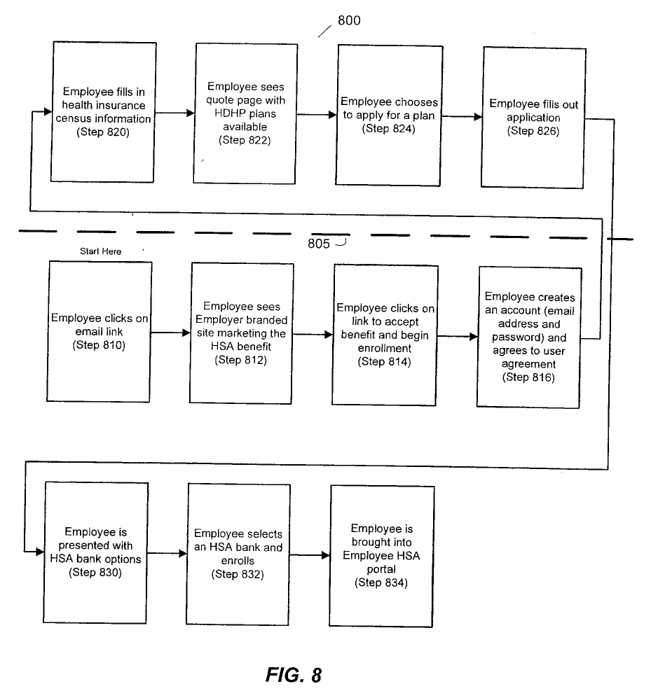

Referring to FIG. 8, a procedural flow-chart diagram illustrating an example use case procedure 800 for setting up an individual employee account and enrolling an employee is shown. In this non limiting exemplary embodiment, the individual or employee enrollment process is shown as being provided by two entities on either side of an imaginary line or boundary 805. Operations on each side of the line possibly being performed by different entities. To start, an employee enters an account setup page (Step 810), such as by clicking on a link in an email sent to the user by the system. The employee enters the site (Step 812), which may display company branding and other introductory or company information. The employee clicks on a link to accept the benefit (Step 814), and begins the enrollment process. The employee creates an account (Step 816), providing a username, password and other credentials, and agrees to the terms of use in a user agreement. The employee then enters health insurance information (Step 820) and reviews the available plans (Step 822). The employee chooses a plan (Step 824), fills out an application (Step 826), and is presented with banking options (Step 830). The employee selects a bank to provide an HSA type account (Step 832), and the system transfers the employee to the Employee HSA portal to perform account management or other functions (Step 834).

Once the employee account is set up, the employee may access account information, benefits information, provider information, and so on. FIG. 9A and FIG. 9B show example web portals 900, 920 displayed to employees within individual accounts and providing an employee interface to the system and its features. Referring to FIG. 9A, a screen 900 displays non-limiting but exemplary insurance premium payment management functions. For example, the employee may access insurance plan information 910, such as the type of policy 912, policy account number 913, policy premium amount 914, and the date of premium payment 916. Fields for this information may be provide for direct text or numeric entry and/or pull-down menus.

Referring to FIG. 9B, a screen 920 displays an account summary for an employee, including recent account activity history 930, HSA information 931 including HSA account balance 932, and so on. In one non-limiting embodiment, a graphical representation 936, such as in the form of a pie-chart showing different pie slices associated with spending percentages, may be displayed to provide a graphical or pictorial representation of HSA spending. Numerical percentage values or monetary amounts may optionally be shown with the graphical information. As discussed with respect to other screens, the system may present other functions and information described herein using similar user interfaces and/or displayed content.

As discussed herein, a system that facilitates the exchange of funds between businesses and employee insurance plans is described. The system may facilitate the use of HSAs, or may perform all processes within the system, using an exchange account. The system enables employers to provide benefits to employees without performing other functions, and enables employees to apply received funds to self chosen health expenses.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the technology is not intended to be exhaustive or to limit the technology to the precise form disclosed above. While specific embodiments of, and examples for, the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the technology provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the technology can be modified, if necessary, to employ the systems, functions, and concepts of the various references described above to provide yet further embodiments of the technology.

These and other changes can be made to the technology in light of the above Detailed Description. While the above description describes certain embodiments of the technology, and describes the best mode contemplated, no matter how detailed the above appears in text, the technology can be practiced in many ways. Details of the data collection and processing system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless the above Detailed Description section explicitly defines such terms. Accordingly, the actual scope of the technology encompasses not only the disclosed embodiments, but also all equivalent ways of practicing or implementing the technology under the claims.

While certain aspects of the technology are presented below in certain claim forms, the inventors contemplate the various aspects of the technology in any number of claim forms. For example, while only one aspect of the technology is recited as embodied in a method, other aspects may likewise be embodied in a computer-readable medium. Accordingly, the inventors reserve the right to add additional claims after filing the application to pursue such additional claim forms for other aspects of the technology.

We claim:

1. A health expense account comprising:
a financial vehicle or container for depositing a monetary value having a present cash equivalence;
the deposited monetary value corresponding to a pre-funded nominal defined contribution health care or medical care employer-to-employee benefit; and
the deposited monetary value deposited into the financial vehicle or container is provided to fully satisfy any employee health care or medical care employment benefit.

2. A health expense account as in claim 1, wherein the financial vehicle or container comprises a financial account or a portion of a financial account at a bank or financial institution or at other institutions permitted under applicable United States and State Laws to establish such financial accounts.

3. A health expense account as in claim 1, wherein the monetary value is deposited by a first entity on a monthly basis for the benefit of a second entity.

4. A health expense account as in claim 3, wherein the first entity is a business employing the second entity, which is an employee.

5. A health expense account as in claim 1, wherein the monetary value is for a health care or medical care employment benefit.

6. A health expense account as in claim 1, wherein the monetary value comprises a health care or medical care defined contribution monetary value.

7. A health expense account as in claim 1, wherein the monetary value deposited into the financial vehicle or container is allocated for making payments for health care or medical care premiums for a high deductible health plan and for funding a health spending account from which other health care and medical care payments may be directed by a controller of the financial vehicle or container.

8. A health expense account as in claim 1, wherein the health plan and the savings account are qualifying High-Deductible Health Plan (HDHP) and Health Savings Account (HSA) as defined by the United States Internal Revenue Code and applicable United States Laws and Regulations.

9. A health care financial product, in which an amount of money is deposited by or on behalf of an employer in an account established for an employee to at least in partially satisfy an employer assumed or legally mandated obligation to provide a health care benefit to the employee, the amount of money deposited being a defined contribution amount with which the employee may procure a health care or medical care insurance plan.

10. A health care financial product as in claim 9, wherein the money is deposited on a monthly basis and the employee may withdraw or direct payment of health care or medical care premiums on a monthly basis.

11. A health care financial product as in claim 10, wherein the employee pays premiums for a high deductible health plan (HDHP) and funds a Health Savings Account (HSA).

12. A health care financial product as in claim 9, wherein the deposited amount of money corresponds to a pre-funded nominal defined contribution health care or medical care employer-to-employee benefit.

13. A health care financial product as in claim 9, wherein the account is established for an employee to completely satisfy the employer assumed or legally mandated obligation to provide a health care benefit to the employee.

14. A method of providing a health care financial product, comprising:
establishing an account by an employer or by an agent authorized by the employer to establish such account for the benefit of an employee; and
depositing an amount of money by or on behalf of the employer to at least in partially satisfy an employer assumed or legally mandated obligation to provide a health care benefit to the employee;
the amount of money deposited being a defined contribution amount with which the employee may procure a health care or medical care insurance plan.

15. A health care plan financial product, comprising:
a health care account with at least one defined contribution deposit made to the account that is owned by an employee, and is for the benefit of the employee, and which is used for payment of an individual health or medical insurance policy premium and optionally payments for health care related expenses; and
the at least one defined contribution deposit made on a monthly or other basis and wherein once deposited are owned by the employee even if the employee ceases to be employed by the employer making the deposit.

16. A network-based system for establishing and maintaining a health expense account and for optimizing an employer and an employee interaction and use of the account, the system comprising:
an account services provider that provides an electronic informational interaction mechanism between an employer and an employee, and directly or indirectly provides a network-based employer portal and a network-based employee portal for that interaction;
a custodial financial institution that receives deposited money funds directly or indirectly from the employer and maintains a financial account that holds the money funds deposited by the employer for the beneficial use of the employee;
a health care insurance provider that provides a health care or medical care insurance plan or policy to the employee as an individual and is able to accept payment of the health care or medical care insurance policy premiums at the direction of the employee from the deposited funds in the financial account; and
the account services provider, the custodial financial institution, and the health care insurance provider are at least intermittently coupled over a computer information network.

17. A network-based system as in claim 16, wherein the system further comprises a health care or medical care insurance broker coupled to the network and identifiable from at least the employee portal to permit the employee to review at least one health care or medical care insurance provider and to procure a health care or medical care insurance plan or policy from the health care insurance provider through the insurance broker.

18. A network-based system as in claim 16, wherein the computer information network comprises the Internet.

19. A network-based system as in claim 16, wherein the system further includes:
means for making a contract between the employer and the custodial financial institution to establish the financial account for deposit into the account and between the employee and the custodial financial institution to access the account for withdrawal or payment to a third party;
means for transferring a defined contribution monetary amount designated for an employee health care or medical care employee benefit from an employer controlled monetary source to the financial account at the custodial financial institution; and
means for transferring a payment amount from the financial account at the custodial financial institution to an account held or designated by the health care insurance provider for payment of a health care or insurance premium owed by the employee.

20. A network-based system as in claim 16, wherein the means for making a contract, means for transferring a defined contribution monetary amount, and means for transferring a payment amount, each comprise a secure institution to institution electronic funds transfer system over the network.

21. A network-based system as in claim 16, wherein the health care or medical insurance plan or policy is an HDHP and the deposited money funds correspond to a pre-funded nominal defined contribution health care or medical care employer-to-employee benefit that fully satisfy any employee health care or medical care employment benefit.

22. A network-based system as in claim 16, further comprising the employer access portal and the employee access portal.

23. A business method for establishing and maintaining a health expense account and for optimizing an employer and an employee interaction and use of the account, the business method comprising:
registering an employer with or through a service provider;
establishing a particular financial account and identifying that particular financial account with a particular employee;
depositing a nominal or pre-funded monetary amount into the financial account in satisfaction of a current defined contribution health care or medical care benefit due the employee;
registering the employee with or through the service provider so that the employee is authorized to access the particular financial account including to make payments from the particular account;
providing health care or medical care insurance information to the employee so that they may individually identify and procure a health care or medical care insurance plan or policy from a subscribing health care or medical care insurance provider; and
facilitating payment of a health care or medical care premium payment directly from the particular financial account to the subscribing health care or medical care insurance provider.

24. A business method as in claim 23, wherein the service provider also provides an electronic informational interaction mechanism between an employer and an employee, and directly or indirectly provides a network-based employer portal and a network-based employee portal for that interaction.

25. A business method as in claim 23, wherein the depositing of funds is made into a particular account at a custodial financial institution that receives deposited money funds directly or indirectly from the employer and maintains a financial account that holds the money funds deposited by the employer for the beneficial use of the employee.

26. A business method as in claim 23, wherein the health care insurance provider provides a health care or medical care insurance plan or policy to the employee as an individual and is able to accept payment of the health care or medical care insurance policy premiums at the direction of the employee from the deposited funds in the particular financial account.

27. A computer program product comprising a computer usable medium having computer readable program code means embodied in said medium for causing an application program to execute on at least one computer for effecting a business method for establishing and maintaining a health expense account and for optimizing an employer and an employee interaction and use of the account, the business method comprising:
registering an employer with or through a service provider;
establishing a particular financial account and identifying that particular financial account with a particular employee;
depositing a nominal or pre-funded monetary amount into the financial account in satisfaction of a current defined contribution health care or medical care benefit due the employee;
registering the employee with or through the service provider so that the employee is authorized to access the particular financial account including to make payments from the particular account;
providing health care or medical care insurance information to the employee so that they may individually identify and procure a health care or medical care insurance plan or policy from a subscribing health care or medical care insurance provider; and
facilitating payment of a health care or medical care premium payment directly from the particular financial account to the subscribing health care or medical care insurance provider.
